(19) United States
(12) Patent Application Publication
(10) Pub. No.: US 2026/0086416 A1
(43) Pub. Date: Mar. 26, 2026

(54) OPTICAL MODULATOR

(71) Applicant: SUMITOMO ELECTRIC INDUSTRIES, LTD., Osaka (JP)

(72) Inventor: Hajime TANAKA, Osaka-shi (JP)

(73) Assignee: SUMITOMO ELECTRIC INDUSTRIES, LTD., Osaka (JP)

(21) Appl. No.: 19/312,432

(22) Filed: Aug. 28, 2025

(30) Foreign Application Priority Data
Sep. 20, 2024 (JP) 2024-163523

(51) Int. Cl. G02F 1/225; G02F 1/21

(52) U.S. Cl. CPC G02F 1/2257; G02F 1/212

(57) ABSTRACT

An optical modulator includes an optical waveguide structure extending along a first direction. The optical waveguide structure includes a first III-V compound semiconductor layer of a first conductivity type, a second III-V compound semiconductor layer of a second conductivity type, a core layer disposed between the first III-V compound semiconductor layer and the second III-V compound semiconductor layer, and a silicon-containing layer. The first III-V compound semiconductor layer is disposed between the silicon-containing layer and the core layer. The second III-V compound semiconductor layer has a width smaller than a width of the core layer.

### CROSS REFERENCE TO RELATED APPLICATIONS

This application claims priority based on Japanese Patent Application No. 2024-163523 filed on Sep. 20, 2024, and the entire contents of the Japanese patent application are incorporated herein by reference.

### TECHNICAL FIELD

The present disclosure relates to optical modulators.

### BACKGROUND

Patent Literature (Japanese Unexamined Patent Application Publication No. 2021-33042) discloses a Mach-Zehnder type optical modulator. The optical modulator includes a substrate formed of indium phosphide (InP). Two arm waveguides are formed on the substrate. In each arm waveguide, a lower contact layer, a lower cladding layer, a core layer, an upper cladding layer, and an upper contact layer are stacked in this order. The lower contact layer and the lower cladding layer are formed of n-type InP doped with silicon. The core layer has a multi quantum well structure. The upper cladding layer is formed of p-type InP doped with zinc. The upper contact layer is formed of p-type indium gallium arsenide (InGaAs) doped with zinc.

### SUMMARY

An optical modulator according to one aspect of the present disclosure includes an optical waveguide structure extending along a first direction. The optical waveguide structure includes a first III-V compound semiconductor layer of a first conductivity type, a second III-V compound semiconductor layer of a second conductivity type, a core layer disposed between the first III-V compound semiconductor layer and the second III-V compound semiconductor layer, and a silicon-containing layer. The first III-V compound semiconductor layer is disposed between the silicon-containing layer and the core layer. The second III-V compound semiconductor layer has a width smaller than a width of the core layer.

### BRIEF DESCRIPTION OF THE DRAWINGS

FIG. 1 is a plan view schematically showing an optical modulator according to an embodiment.

FIG. 2 is a plan view schematically showing a portion of the optical modulator of FIG. 1.

FIG. 3 is a cross-sectional view taken along line III-III of FIG. 2.

FIG. 4 is a cross-sectional view taken along line IV-IV of FIG. 2.

FIG. 5 is a cross-sectional view taken along line V-V of FIG. 2.

FIG. 6 is a cross-sectional view showing an example of a configuration of a first III-V compound semiconductor layer, a second III-V compound semiconductor layer, a core layer, and a silicon-containing layer.

FIG. 7 is a cross-sectional view showing another example of a configuration of a first III-V compound semiconductor layer, a second III-V compound semiconductor layer, a core layer, and a silicon-containing layer.

### DETAILED DESCRIPTION

The present disclosure provides an optical modulator that reduces capacitance in an optical waveguide structure.

### Description of Embodiments of Present Disclosure

First, the contents of the embodiments of the present disclosure will be listed and described.

(1) An optical modulator according to one embodiment includes an optical waveguide structure extending along a first direction. The optical waveguide structure includes a first III-V compound semiconductor layer of a first conductivity type, a second III-V compound semiconductor layer of a second conductivity type, a core layer disposed between the first III-V compound semiconductor layer and the second III-V compound semiconductor layer, and a silicon-containing layer. The first III-V compound semiconductor layer is disposed between the silicon-containing layer and the core layer. The second III-V compound semiconductor layer has a width smaller than a width of the core layer.

According to the optical modulator, the capacitance in the optical waveguide structure can be reduced.

(2) According to the above (1), the second III-V compound semiconductor layer may include a lower region adjacent to the core layer. In the lower region, the width of the second III-V compound semiconductor layer may decrease toward the core layer.

In this case, the capacitance in the optical waveguide structure can be further reduced.

(3) In the above (1) or (2), the first direction may be a same as a [0-11] direction of the second III-V compound semiconductor layer.

(4) In any one of the above (1) to (3), the second III-V compound semiconductor layer may have a thickness greater than a thickness of the core layer.

(5) In any one of the above (1) to (4), the first III-V compound semiconductor layer may have a thickness equal to or less than a thickness of the core layer.

### Details of Embodiments of Present Disclosure

Hereinafter, embodiments of the present disclosure will be described in detail with reference to the accompanying drawings. In the description of the drawings, the same reference numerals are used for the same or equivalent elements, and redundant description will be omitted. In the drawings, an X-axis direction, a Y-axis direction, and a Z-axis direction that intersect each other are shown as necessary. The X-axis direction, the Y-axis direction, and the Z-axis direction are, for example, orthogonal to each other.

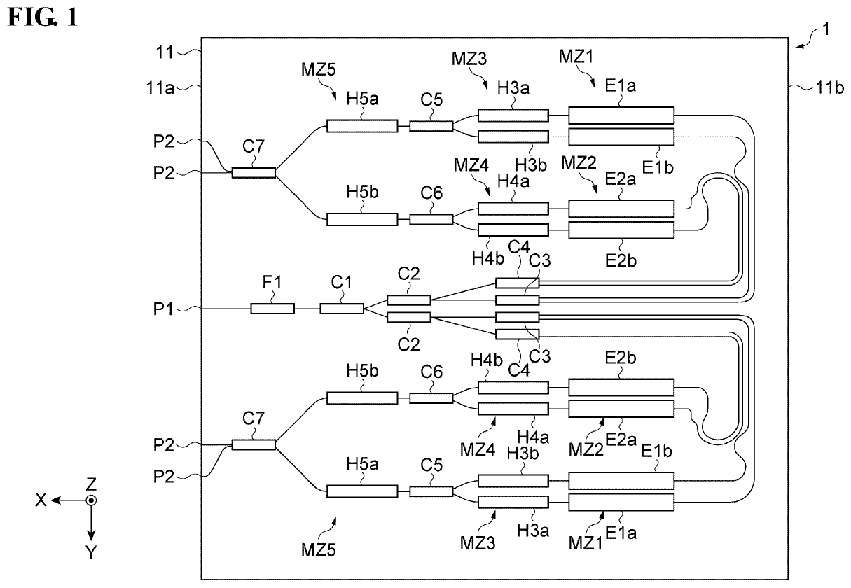

FIG. 1 is a plan view schematically showing an optical modulator according to the embodiment. An optical modulator 1 can modulate the intensity or phase of light in optical communication, for example, and generate a modulation signal. The optical modulator 1 may include an input port P1, a plurality of Mach-Zehnder modulator portions MZ1, MZ2, MZ3, MZ4, and MZ5, an optical filter F1, a plurality of optical couplers C1, C2, C3, C4, C5, C6, and C7, and a plurality of output ports P2. The input port P1, the plurality of Mach-Zehnder modulator portions MZ1 to MZ5, the optical filter F1, the plurality of optical couplers C1 to C7, and the plurality of output ports P2 may be provided on a substrate 11.

The substrate 11 extends along the X-axis direction and the Y-axis direction. The main surface of the substrate 11 may have a substantially rectangular shape. The main surface of the substrate 11 includes an edge 11a extending in the Y-axis direction and an edge 11b extending in the Y-axis direction. The edge 11b is located opposite to the substrate 11 from the edge 11a in the X-axis direction. The edge 11a may be provided with the input port P1 and the plurality of output ports P2. The input port P1 is located in the middle of the plurality of output ports P2.

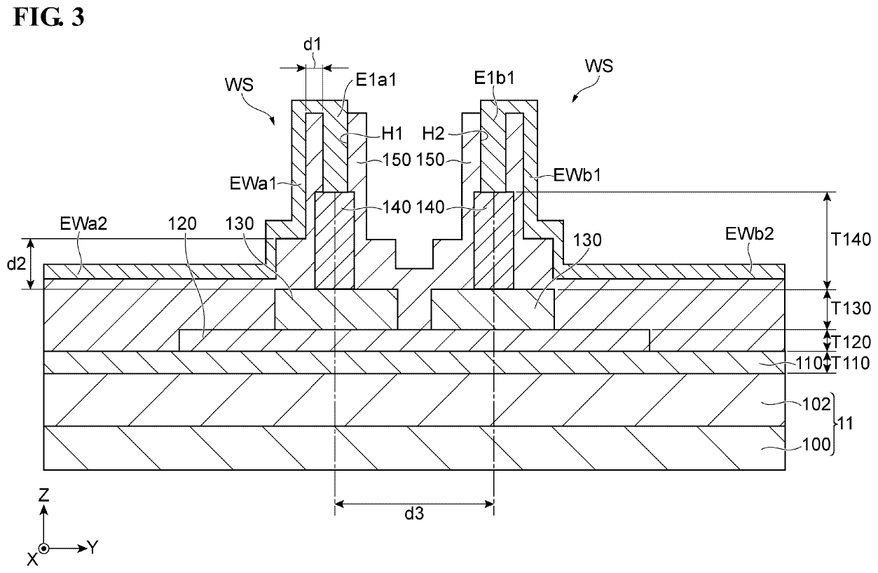

The input port P1 is optically coupled to the optical filter F1 by an optical waveguide. The optical filter F1 is, for example, an optical component having one input and one output. The optical filter F1 is optically coupled to the optical coupler C1 by an optical waveguide. The optical coupler C1 is, for example, a one input two output multi-mode interface (MMI) coupler. The optical coupler C1 is optically coupled to a plurality of (for example, two) optical couplers C2 by a plurality of (for example, two) optical waveguides, receptively. Each optical coupler C2 is, for example, a one input two output MMI coupler. Each optical coupler C2 is optically coupled to optical couplers C3 and C4 by a plurality of (for example, two) optical waveguides, receptively. Each of the optical couplers C3 and C4 is, for example, a one input two output MMI coupler. The optical waveguide may be formed in a silicon-containing layer 110 (see FIG. 3) described later. When the optical waveguide is formed in the silicon-containing layer 110, the core of the optical waveguide that includes silicon. The core of the optical waveguide has a width of, for example, 0.5 μm. The core of the optical waveguide has a height of, for example, 0.2 μm. The optical couplers C1 to C7 and the optical filter F1 may be formed in the silicon-containing layer 110. The optical couplers C1 to C7 and the optical filter F1 may have a width greater than a width of the optical waveguide. No III-V group compound semiconductor is provided on the optical waveguide. The upper surfaces of the optical waveguide, the optical couplers C1 to C7, and the optical filter F1 may be covered with an insulating film.

The optical coupler C3 is optically coupled to the first arm waveguide and the second arm waveguide of the Mach-Zehnder modulator portion MZ1 by a plurality of (for example, two) optical waveguides, receptively. An electrode portion E1a for modulation is provided on the first arm waveguide of the Mach-Zehnder modulator portion MZ1. An electrode portion E1b for modulation is provided on the second arm waveguide of the Mach-Zehnder modulator portion MZ1.

The first arm waveguide and the second arm waveguide of the Mach-Zehnder modulator portion MZ1 are optically coupled to the first arm waveguide and the second arm waveguide of a Mach-Zehnder modulator portion MZ3, respectively, by a plurality of (for example, two) optical waveguides. A heater H3a is provided on the first arm waveguide of the Mach-Zehnder modulator portion MZ3. A heater H3b is provided on the second arm waveguide of the Mach-Zehnder modulator portion MZ3.

The first arm waveguide and the second arm waveguide of the Mach-Zehnder modulator portion MZ3 are optically coupled to the optical coupler C5 by a plurality of (for example, two) optical waveguides. The optical coupler C5 is, for example, a two input one output MMI coupler. The optical coupler C5 is optically coupled to the first arm waveguide of a Mach-Zehnder modulator portion MZ5 by an optical waveguide. A heater H5a is provided on the first arm waveguide of the Mach-Zehnder modulator portion MZ5. One optical coupler C3, one Mach-Zehnder modulator portion MZ1, one Mach-Zehnder modulator portion MZ3, and one optical coupler C5 form one sub-Mach-Zehnder modulator.

An optical coupler C4 is optically coupled to the first arm waveguide and the second arm waveguide of a Mach-Zehnder modulator portion MZ2 by a plurality of (for example, two) optical waveguides, receptively. An electrode portion E2a for modulation is provided on the first arm waveguide of the Mach-Zehnder modulator portion MZ2. An electrode portion E2b for modulation is provided on the second arm waveguide of the Mach-Zehnder modulator portion MZ2.

The first arm waveguide and the second arm waveguide of the Mach-Zehnder modulator portion MZ2 are optically coupled to the first arm waveguide and the second arm waveguide of a Mach-Zehnder modulator portion MZ4, respectively, by a plurality of (for example, two) optical waveguides. A heater H4a is provided on the first arm waveguide of the Mach-Zehnder modulator portion MZ4. A heater H4b is provided on the second arm waveguide of the Mach-Zehnder modulator portion MZ4. One optical coupler C4, one Mach-Zehnder modulator portion MZ2, one Mach-Zehnder modulator portion MZ4, and one optical coupler C6 form one sub-Mach-Zehnder modulator.

The first arm waveguide and the second arm waveguide of the Mach-Zehnder modulator portion MZ4 are optically coupled to the optical coupler C6 by a plurality of (for example, two) optical waveguides. The optical coupler C6 is, for example, a two input one output MMI coupler. The optical coupler C6 is optically coupled to the second arm waveguide of the Mach-Zehnder modulator portion MZ5 by an optical waveguide. A heater H5b is provided on the second arm waveguide of the Mach-Zehnder modulator portion MZ5.

The first arm waveguide and the second arm waveguide of the Mach-Zehnder modulator portion MZ5 are optically coupled to the optical coupler C7 by a plurality of (for example, two) optical waveguides. The optical coupler C7 is, for example, a two input two output MMI coupler. The optical coupler C7 is optically coupled to the plurality of (for example, two) output ports P2 by a plurality of (for example, two) optical waveguides, respectively.

The optical modulator 1 includes four sub-Mach-Zehnder modulators. Light passes through Mach-Zehnder modulator portions MZ1 to MZ5 and output from the output port P2 after being input to the input port P1. Light is converted into four different signal lights by the four sub-Mach-Zehnder modulators. The four signal lights are multiplexed by two optical couplers C7. The four signal lights are multiplexed and output from two output ports P2 of the four output ports P2. The Mach-Zehnder modulator portions MZ1 and MZ2 may include an arm waveguide including a III-V group compound semiconductor. Each of the arm waveguides of the Mach-Zehnder modulator portions MZ1 and MZ2 may include a waveguide section including a III-V group compound semiconductor and a waveguide section not including a III-V group compound semiconductor. For example, the waveguide section including the III-V group compound semiconductor corresponds to an optical waveguide structure WS to be described later. In the waveguide section that does not include the III-V group compound semiconductor, each arm waveguide has a core that includes silicon. In each arm waveguide, the waveguide section including the III-V group compound semiconductor is optically coupled to the waveguide section that does not include III-V group compound semiconductor. In the arm waveguide, the core that includes silicon and a core layer 130 (see FIG. 3) included in the III-V group compound semiconductor are optically coupled. The refractive index of the arm waveguide can be changed by applying a high-frequency voltage between the electrode portions E1a, E1b, E2a, and E2b and the ground electrode. The Mach-Zehnder modulator portions MZ3 to MZ5 include an arm waveguide that includes silicon. Each of the first arm waveguide and the second arm waveguide of the Mach-Zehnder modulator portions MZ3 to MZ5 does not necessarily include a group III-V compound semiconductor. The refractive index of the arm waveguide can be changed by heating the arm waveguide with the heaters H3a, H3b, H4a, H4b, H5a, and H5b. The heaters H3a, H3b, H4a, H4b, H5a, and H5b may be conductor patterns for performing resistance heating.

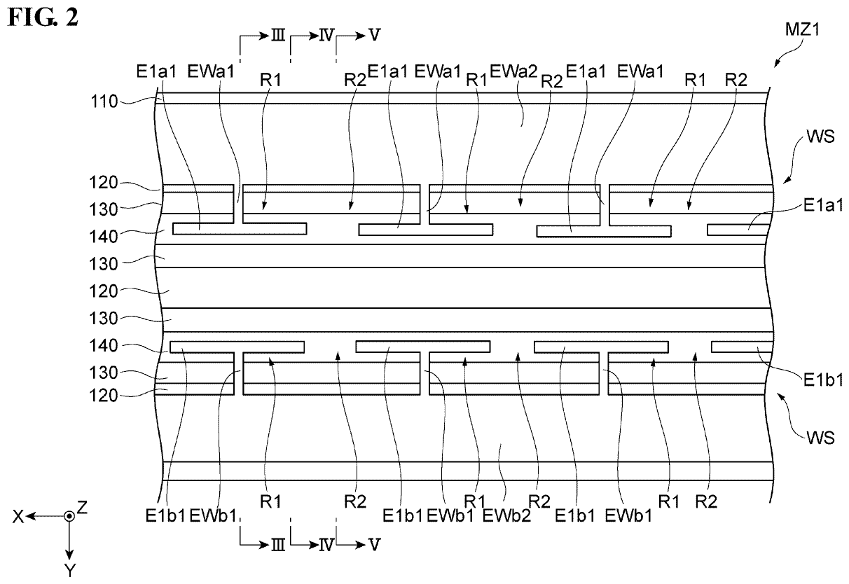

FIG. 2 is a plan view schematically showing a portion of the optical modulator of FIG. 1. FIG. 2 shows a portion of the first arm waveguide in which the electrode portion E1a is provided and a portion of the second arm waveguide in which the electrode portion E1b is provided in the Mach-Zehnder modulator portion MZ1. As shown in FIG. 2, the first arm waveguide and the second arm waveguide of the Mach-Zehnder modulator portion MZ1 include the optical waveguide structure WS extending along the X-axis direction (first direction). The electrode portion E1a and the electrode portion E1b are provided on the optical waveguide structure WS. Each of the first arm waveguide and the second arm waveguide of the Mach-Zehnder modulator portion MZ2 may include the optical waveguide structure WS.

As shown in FIG. 2, the optical waveguide structure WS includes a plurality of first regions R1 spaced apart from each other along the X-axis direction and a second region R2 located between the plurality of first regions R1. The plurality of first regions R1 and the respective second regions R2 are electrically separated from each other.

The electrode portion E1a includes an electrode E1a1, a wiring EWa1, and a wiring EWa2. In the embodiment, the electrode E1a1 is located on each first region R1 of the optical waveguide structure WS included in the first arm waveguide of the Mach-Zehnder modulator portion MZ1. Each electrode E1a1 is connected to the wiring EWa2 via the wiring EWa1. Each electrode E1a1 extends along the X-axis direction. Each wiring EWa1 extends along the Y-axis direction. The wiring EWa2 extends in the X-axis direction over the plurality of first regions R1. The electrode E1a1, the wiring EWa1, and the wiring EWa2 are located on the substrate 11. The electrode E1a1, the wiring EWa1, and the wiring EWa2 may include a metal.

The electrode portion E1b includes an electrode E1b1, a wiring EWb1, and a wiring EWb2. In the embodiment, the electrode E1b1 is located on each first region R1 of the optical waveguide structure WS included in the second arm waveguide of the Mach-Zehnder modulator portion MZ1. Each electrode E1b1 is connected to the wiring EWb2 via the wiring EWb1. Each electrode E1b1 extends along the X axis. Each wiring EWb1 extends along the Y axis. The wiring EWb2 extends in the X-axis direction over the plurality of first regions R1. The electrode E1b1, the wiring EWb1, and the wiring EWb2 are located on the substrate 11. The electrode E1b1, the wiring EWb1, and the wiring EWb2 may include a metal.

FIG. 3 is a cross-sectional view taken along line III-III of FIG. 2. FIG. 3 shows a cross section of the first region R1 at a position where the electrode E1a1, the wiring EWa1, the electrode E1b1, and the wiring EWb1 are disposed. As shown in FIG. 3, each optical waveguide structure WS includes the silicon-containing layer 110, a first III-V compound semiconductor layer 120 of a first conductivity type (for example, n-type), the core layer 130, and a second III-V compound semiconductor layer 140 of a second conductivity type (for example, p-type). The second conductivity type is a conductivity type opposite to the first conductivity type. The silicon-containing layer 110 may be disposed between the substrate 11 and the first III-V compound semiconductor layer 120. The first III-V compound semiconductor layer 120 is disposed between the silicon-containing layer 110 and the core layer 130. The core layer 130 is disposed between the first III-V compound semiconductor layer 120 and the second III-V compound semiconductor layer 140.

The substrate 11 may include a silicon substrate 100 and a silicon oxide layer 102 on the silicon substrate 100. The silicon oxide layer 102 is disposed between the silicon substrate 100 and the silicon-containing layer 110. The thickness of the silicon substrate 100 may be 100 μm or more. The thickness of the silicon oxide layer 102 may be 2 μm or more. In one example, the thickness of the silicon substrate 100 is 500 μm and the thickness of the silicon oxide layer 102 is 2 μm.

The silicon-containing layer 110 may be disposed between the silicon oxide layer 102 and the first III-V compound semiconductor layer 120. The silicon-containing layer 110 may be formed by filling with silicon. The silicon-containing layer 110 may be a silicon layer. The silicon-containing layer 110 may have a thickness T120 smaller than a thickness T110 of the first III-V compound semiconductor layer 120. The thickness T110 of the silicon-containing layer 110 may be 0.1 μm to 0.5 μm. In one example, the thickness T110 is 0.3 μm.

The first III-V compound semiconductor layer 120 may include at least one of indium phosphide (InP), indium gallium arsenide phosphide (InGaAsP), aluminum indium gallium arsenide (AlInGaAs), gallium arsenide (GaAs), or aluminum gallium arsenide (AlGaAs).

Examples of n-type dopants include silicon (Si). The first III-V compound semiconductor layer 120 may have a thickness T120 equal to or less than the thickness T130 of the core layer 130.

The thickness T120 of the first III-V compound semiconductor layer 120 may be 0.1 μm to 1.0 μm. In one example, the thickness T120 is 0.6 μm.

When the thickness T120 of the first III-V compound semiconductor layer 120 is 1.0 μm or less, it is possible to reduce the transition of light from being reduced when the light is transited from the optical waveguide including the silicon-containing layer 110 to the core layer 130 including the III-V group compound semiconductor. In the arm waveguide, it is possible to reduce optical coupling between an optical waveguide section having a core including silicon and a waveguide section that includes a III-V group compound semiconductor from being weakened. It is possible to avoid the light modulation performed by the core layer 130 from becoming insufficient.

When the thickness T120 of the first III-V compound semiconductor layer 120 is 0.1 μm or more, it is possible to reduce the increase in electrical resistance of the f first III-V compound semiconductor layer 120. It is possible to reduce the decrease in the efficiency of the electric field applied to the core layer 130 through the first III-V compound semiconductor layer 120. It is possible to reduce the decrease in modulation efficiency in the high frequency band.

The core layer 130 includes a non-doped III-V group compound semiconductor. The core layer 130 may have a multi quantum well structure or may be a bulk layer. Examples of III-V group compound semiconductors include InGaAsP and AlInGaAs. The core layer 130 has the thickness T130. The thickness T130 may be from 0.1 μm to 0.9 μm. In one example, the thickness T130 is 0.3 μm.

The second III-V compound semiconductor layer 140 may include at least one of InP, InGaAsP, AlInGaAs, GaAs, or AlGaAs. Examples of p-type dopants include zinc (Zn). The second III-V compound semiconductor layer 140 may have the thickness T140 greater than a thickness T130. The thickness T140 may be greater than the thickness T120 or may be greater than the thickness T110. The thickness T140 may be greater than the sum of the thickness T120 and the thickness T110. The thickness T140 of the second III-V compound semiconductor layer 140 may be 1.5 μm to 2.2 μm. In one example, the thickness T140 is 1.9 μm. The X-axis direction, which is the direction in which the optical waveguide structure WS extends, may be parallel to the [0-11] direction of the second III-V compound semiconductor layer 140.

Alternatively, the X-axis direction may be parallel to as the [0-1-1] direction of the second III-V compound semiconductor layer 140.

The first arm waveguide and the second arm waveguide of the Mach-Zehnder modulator portion MZ1 may further include an insulating film 150. The insulating film 150 may be a silicon oxide film or a benzocyclobutene (BCB) film. Each optical waveguide structure WS may be covered by the insulating film 150. Thus, the silicon-containing layer 110, the first III-V compound semiconductor layer 120, the core layer 130, and the second III-V compound semiconductor layer 140 may be covered by the insulating film 150. In the embodiment, as shown in FIG. 3, the wiring EWa1 and the wiring EWa2 are provided on the insulating film 150. Similarly, the wiring EWb1 and the wiring EWb2 are also provided on the insulating film 150. It is noted that, in FIG. 2, the insulating film 150 is not shown in order to clearly show the respective portions.

The insulating film 150 has an opening H1 on the second III-V compound semiconductor layer 140 of the first arm waveguide. Inside the opening H1, the upper surface of the second III-V compound semiconductor layer 140 of the first arm waveguide is exposed. The electrode E1a1 is provided in the opening H1. Thus, the electrode E1a1 is connected to the second III-V compound semiconductor layer 140 of the second arm waveguide.

The wiring EWa1 extends in the Z-axis direction along the side surface of the insulating film 150. Further, the wiring EWa1 may extend in the Y-axis direction from the core layer 130 to the first III-V compound semiconductor layer 120. The wiring EWa2 may extend in the Y-axis direction in the outer side of first III-V compound semiconductor layer 120.

A distance d1 between the electrode E1a1 and the side surface of the insulating film 150 may be 300 nm to 600 nm. The distance d1 is the shortest distance between the electrode E1a1 and the side surface of the insulating film 150 in the Y-axis direction. A distance d2 between the wiring EWa1 and the upper surface of the core layer 130 may be 600 nm to 900 nm. The distance d2 is the thickness of the insulating film 150 on the core layer 130 in the Z-axis direction.

The insulating film 150 has an opening H2 on the second III-V compound semiconductor layer 140 of the second arm waveguide. Inside the opening H2, the upper surface of the second III-V compound semiconductor layer 140 of the second arm waveguide is exposed. The electrode E1b1 is provided in the opening H2. Thus, the electrode E1b1 is connected to the second III-V compound semiconductor layer 140 of the second arm waveguide.

The wiring EWb1 extends in the Z-axis direction along the side surface of the insulating film 150. Further, the wiring EWb1 may extend in the Y-axis direction from the core layer 130 to the first III-V compound semiconductor layer 120. The wiring EWb2 may extend in the Y-axis direction in the outer side of the first III-V compound semiconductor layer 120. A distance between the electrode E1b1 and the side surface of the insulating film 150 may be the same as the distance d1. A distance between the wiring EWb1 and the upper surface of the core layer 130 may be the same as the distance d2.

As shown in FIG. 3, an interval d3 between the optical waveguide structure WS of the first arm waveguide and the optical waveguide structure WS of the second arm waveguide may be, for example, 5 μm to 20 μm. The interval d3 is a distance between the center of the second III-V compound semiconductor layer 140 of the first arm waveguide and the center of the second III-V compound semiconductor layer 140 of the second arm waveguide in the Y-axis direction.

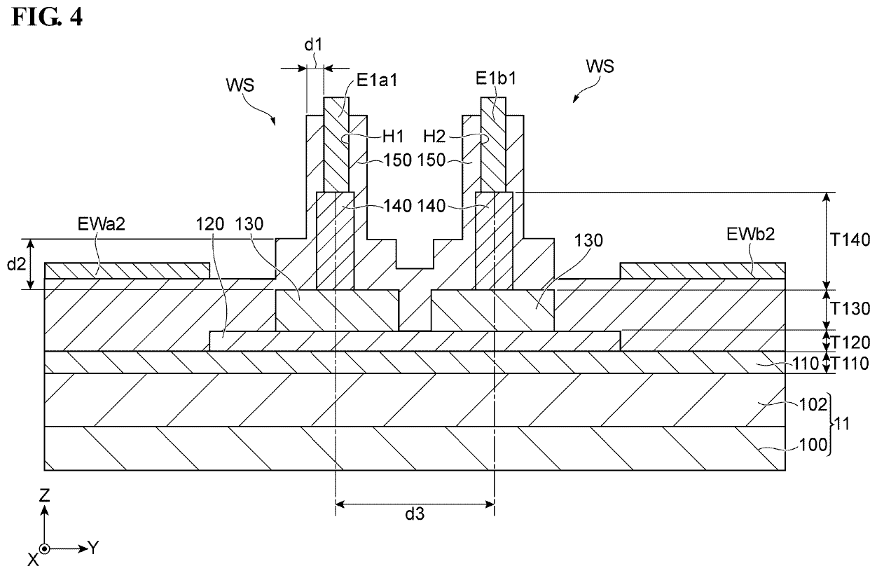

FIG. 4 is a cross-sectional view taken along line IV-IV of FIG. 2. FIG. 4 shows a cross section of the first region R1 at a position where only the electrode E1a1 and the electrode E1b1 are disposed. As shown in FIG. 4, in the first region R1 at the position where only the electrode E1a1 and the electrode E1b1 are disposed, the optical waveguide structure WS also includes the silicon-containing layer 110, the first III-V compound semiconductor layer 120, the core layer 130, and the second III-V compound semiconductor layer 140. In the first region R1 at the position where only the electrode E1a1 and the electrode E1b1 are disposed, the wiring EWa1 and the wiring EWb1 are not provided on the insulating film 150 covering the core layer 130 and the first III-V compound semiconductor layer 120. Thus, in the first region R1 at the position where only the electrode E1a1 and the electrode E1b1 are disposed, the surface of the insulating film 150 covering the core layer 130 and the first III-V compound semiconductor layer 120 is uncovered.

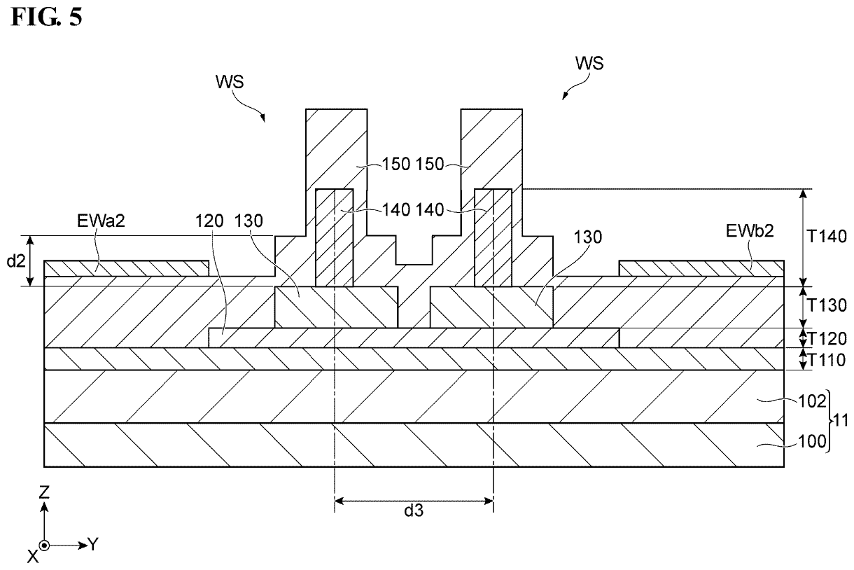

FIG. 5 is a cross-sectional view taken along line V-V of FIG. 2. FIG. 5 shows a cross section of the second region R2. As shown in FIG. 5, in the second region R2, the optical waveguide structure WS also includes the silicon-containing layer 110, the first III-V compound semiconductor layer 120, the core layer 130, and the second III-V compound semiconductor layer 140. In the second region R2, the openings H1 and H2 are not formed in the insulating film 150. That is, in the second region R2, the insulating film 150 covers the upper surface of the second III-V compound semiconductor layer 140. In the second region R2, the electrode E1a1 is not provided on the insulating film 150 covering the second III-V compound semiconductor layer 140. Thus, the surface of the insulating film 150 covering the second III-V compound semiconductor layer 140 is uncovered in the second region R2. In the second region R2, the wiring EWa1 and the wiring EWb1 are not provided on the insulating film 150 covering the core layer 130 and the first III-V compound semiconductor layer 120. Thus, the surface of the insulating film 150 covering the core layer 130 and the first III-V compound semiconductor layer 120 is also uncovered in the first region R1.

A ground electrode is connected to the first III-V compound semiconductor layer 120. A voltage is applied between the electrode E1a1 and the ground electrode. Between the electrode E1a1 and the ground electrode, a direct current reverse bias voltage and an alternating-current voltage are, for example, applied in a superimposed manner. A voltage is applied between the electrode E1b1 and the ground electrode. Between the electrode E1b1 and the ground electrode, a direct current reverse bias voltage and an alternating-current voltage are, for example, applied in a superimposed manner. Thus, an electric signal flows between the electrode E1a1 and the ground electrode and between the electrode E1b1 and the ground electrode. The refractive indices of the first III-V compound semiconductor layer 120, the core layer 130, and the second III-V compound semiconductor layer 140 are changed by the electric signal. The phase of light propagating through the optical waveguide structure WS is modulated by the change in the refractive index.

The light propagating through the core layer 130 may propagate through the silicon-containing layer 110, the first III-V compound semiconductor layer 120, and the second III-V compound semiconductor layer 140.

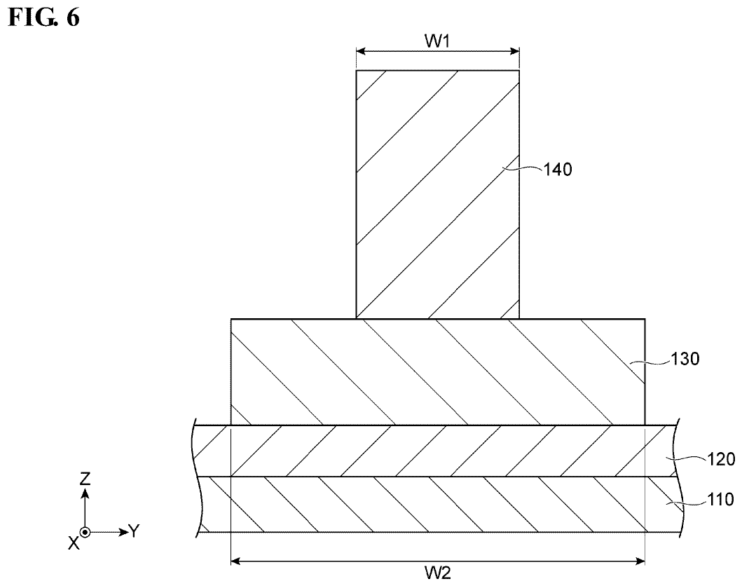

Next, the relationship between the silicon-containing layer 110, the first III-V compound semiconductor layer 120, the core layer 130, and the second III-V compound semiconductor layer 140 will be described in more detail with reference to FIG. 6. FIG. 6 is a cross-sectional view showing the configuration of the first III-V compound semiconductor layer, the second III-V compound semiconductor layer, the core layer, and the silicon-containing layer. It is noted that, in FIG. 6, the substrate 11 is omitted for convenience of explanation.

As shown in FIG. 6, the second III-V compound semiconductor layer 140 has a width W1 that is smaller than a width W2 of the core layer 130. The width W1 is the length of the second III-V compound semiconductor layer 140 in the Y-axis direction. The width W1 may be a width of the lower surface of the second III-V compound semiconductor layer 140. The lower surface of the second III-V compound semiconductor layer 140 may be in contact with the upper surface of the core layer 130. The width W2 is the length of the core layer 130 in the Y-axis direction. The width W2 may be a width on the upper surface of the core layer 130. The width W1 may be 1.2 μm to 1.9 μm. The width W2 may be 5μm to 12 μm. The ratio of width W1 to width W2 may be 10% to 20%.

The width W1 may be smaller than the width of the first III-V compound semiconductor layer 120. That is, the second III-V compound semiconductor layer 140 may have the width W1 smaller than a width of the first III-V compound semiconductor layer 120. The width of the first III-V compound semiconductor layer 120 is the length of the first III-V compound semiconductor layer 120 in the Y-axis direction. The width of the first III-V compound semiconductor layer 120 may be 20 μm to 40 μm. A ratio of the width W1 to the width of the first III-V compound semiconductor layer 120 may be 3% to 10%.

The width W2 may be smaller than the width of the first III-V compound semiconductor layer 120. That is, the core layer 130 may have the width W2 smaller than the width of the first III-V compound semiconductor layer 120. A ratio of the width W2 to the width of the first III-V compound semiconductor layer 120 may be 13% to 40%.

According to the optical modulator 1, the capacitance in the optical waveguide structure WS can be reduced. For example, the optical modulator 1 can reduce the capacitance in the optical waveguide structure WS as compared with an optical modulator in which the width of the first III-V compound semiconductor layer and the width of the second III-V compound semiconductor layer are the same. When the width W1 at the lower surface of the second III-V compound semiconductor layer 140 decreases, the capacitance in the optical waveguide structure WS is reduced.

The optical waveguide structure WS can be manufactured as follows. First, the second III-V compound semiconductor layer 140, the core layer 130, and the first III-V compound semiconductor layer 120 are sequentially stacked on a surface of a III-V group compound semiconductor substrate. The III-V group compound semiconductor substrate is, for example, an InP substrate or a GaAs substrate. Each layer is formed by, for example, a metal organic chemical vapor deposition (MOCVD) method or a molecular beam epitaxy (MBE) method.

Next, the III-V group compound semiconductor substrate is cut along the scribe lines formed on the surface of the III-V group compound semiconductor substrate, thereby forming a plurality of chips.

Meanwhile, the optical waveguide and the silicon-containing layer 110 are formed by patterning a silicon layer positioned on a surface of a silicon on insulator (SOI) substrate.

Next, the chip is bonded to the SOI substrate so that the first III-V compound semiconductor layer 120 is bonded to the silicon-containing layer 110. The bonding is performed by, for example, a surface activation bonding method using nitrogen plasma. After the surface of the SOI substrate and the surface of the chip are exposed to nitrogen plasma, receptively, the surface of the chip is brought into contact with the surface of the SOI substrate. Thereafter, the SOI substrate and the chip are heated while applying a load thereto.

Next, the chips of the III-V group compound semiconductor substrate are removed by, for example, wet etching.

Next, the second III-V compound semiconductor layer 140, the core layer 130, and the first III-V compound semiconductor layer 120 are processed by photolithography and etching. For example, the second III-V compound semiconductor layer 140, the core layer 130, and the first III-V compound semiconductor layer 120 are processed by dry etching or wet etching. The width W1 of the second III-V compound semiconductor layer 140 is processed to be smaller than the width W2 of the core layer 130, and the width W2 of the core layer 130 is smaller than the width of the first III-V compound semiconductor layer 120. Thus, the optical waveguide structure WS is formed. Thereafter, the insulating film 150 covering the optical waveguide structure WS is formed. Subsequently, the openings H1 and H2 are formed in the insulating film 150 by photolithography and etching. Thereafter, the electrode E1a1 is formed in the opening H1 and the electrode E1b1 is formed in the opening H2 by lift-off.

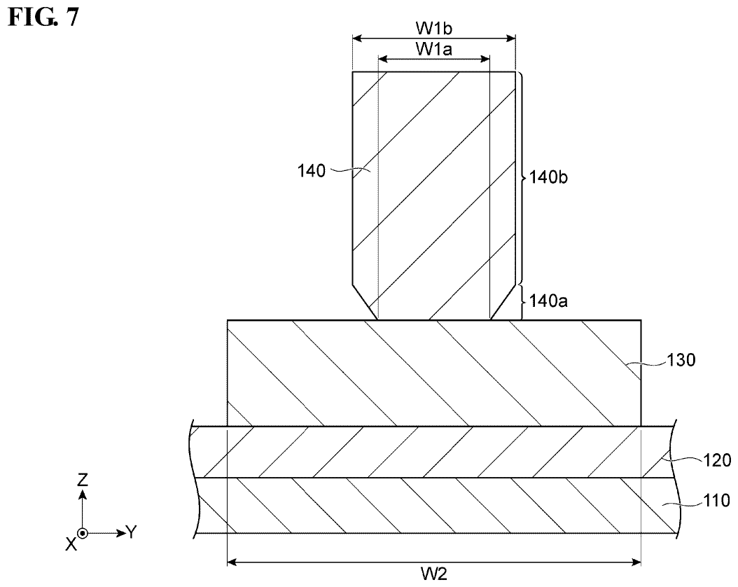

Next, modification of the optical waveguide structure WS will be described with reference to FIG. 7. FIG. 7 is a cross-sectional view showing another example of the configuration of the first III-V compound semiconductor layer, the second III-V compound semiconductor layer, the core layer, and the silicon-containing layer. In the present modification, the structure of the second III-V compound semiconductor layer 140 is different from the above-described embodiment. The following description will be made mainly on the difference between the above-described embodiment and the present modification. It is noted that, in FIG. 7, the substrate 11 is omitted for convenience of explanation.

In the present modification, the second III-V compound semiconductor layer 140 includes a lower region 140a adjacent to the core layer and an upper region 140b located opposite to the lower region 140a. In the second III-V compound semiconductor layer 140, the lower region 140a and the upper region 140b are formed integrally, for example.

The height of the lower region 140a may be 0.1 μm to 0.3 μm. A ratio of a height of the lower region 140a to the thickness T140 of the second III-V compound semiconductor layer 140 may be 5% to 15%.

In the present modification, the second III-V compound semiconductor layer 140 has a width W1a in the lower region 140a. In the upper region 140b, the second III-V compound semiconductor layer 140 has a width W1b. The width W1a is the length of the lower region 140a in the Y-axis direction. The width W1b is the length of the upper region 140b in the Y-axis direction. The width W1a may be 1.1 μm to 1.8 μm. The width W1b may be 1.2 μm to 1.9 μm.

In the present modification, the width W1a decrease toward the core layer 130. The width W1a is minimized at the lower surface of the second III-V compound semiconductor layer 140 and maximized at the boundary with the upper region 140b. The width W1a of the second III-V compound semiconductor layer 140 at the lower surface thereof may be 1.1 μm to 1.8 μm. The width W1a may decrease continuously or may decrease stepwise toward the core layer 130.

In the upper region 140b, the width W1b may be constant. The width W1b may be greater than the width W1a. When the width W1b is greater than the width W1a, it is easy to obtain a width sufficient for providing the electrodes E1a1 and E1b1. The ratio of width W1a to width W1b may be 85% to 95%. Width W1a and the width W1b are smaller than width W2. Thus, in this modification, the second III-V compound semiconductor layer 140 has widths W1a and W1b smaller than the width W2 of the core layer 130.

According to the present modification, the capacitance in the optical waveguide structure WS can be further reduced.

In the present modification, the second III-V compound semiconductor layer 140 is processed as follows, for example. First, dry etching for processing the second III-V compound semiconductor layer 140 is performed so that the width W1b of the second III-V compound semiconductor layer 140 is smaller than the width W2 of the core layer 130. Next, a region of the second III-V compound semiconductor layer 140 that is to be the lower region 140a is processed by wet etching. Thus, the lower region 140a having the width W1a is formed in the second III-V compound semiconductor layer 140. When the X-axis direction is parallel to the [0-11] direction of the second III-V compound semiconductor layer 140, the width W1a of the lower region 140a decreases toward the core layer 130.

Although the preferred embodiments of the present disclosure have been described in detail, the present disclosure is not limited to the above embodiments.

The embodiments disclosed herein are to be considered in all respects as illustrative and not restrictive. The scope of the present invention is defined not by the above description but by the appended claims, and is intended to include any modifications within the meaning and scope equivalent to the appended claims.

What is claimed is:

1. An optical modulator comprising:
an optical waveguide structure extending along a first direction,
wherein the optical waveguide structure includes:
a first III-V compound semiconductor layer of a first conductivity type;
a second III-V compound semiconductor layer of a second conductivity type;
a core layer disposed between the first III-V compound semiconductor layer and the second III-V compound semiconductor layer; and
a silicon-containing layer,
wherein the first III-V compound semiconductor layer is disposed between the silicon-containing layer and the core layer, and
wherein the second III-V compound semiconductor layer has a width smaller than a width of the core layer.

2. The optical modulator according to claim 1,
wherein the second III-V compound semiconductor layer includes a lower region adjacent to the core layer, and
wherein, in the lower region, the width of the second III-V compound semiconductor layer decreases toward the core layer.

3. The optical modulator according to claim 1,
wherein the first direction is parallel to a [0-11] direction of the second III-V compound semiconductor layer.

4. The optical modulator according to claim 1,
wherein the second III-V compound semiconductor layer has a thickness greater than a thickness of the core layer.

5. The optical modulator according to claim 1,
wherein the first III-V compound semiconductor layer has a thickness equal to or less than a thickness of the core layer.
